(19) United States
(12) Patent Application Publication
(10) Pub. No.: US 2024/0339596 A1
(43) Pub. Date: Oct. 10, 2024

(54) ALL-SOLID-STATE BATTERY INCLUDING NEGATIVE ELECTRODE LAYER IN THICK-FILM FORM AND METHOD OF MANUFACTURING THE SAME

(71) Applicants: Hyundai Motor Company, Seoul (KR); Kia Corporation, Seoul (KR)

(72) Inventors: Dong Hyun Kim, Busan (KR); Ju Yeon Lee, Busan (KR); Jae Hyeon Rim, Hwaseong (KR); Yoon Jae Han, Uiwang (KR); Chang Young Choi, Seoul (KR); Sang Mo Kim, Hwaseong (KR); Yoon Gon Kim, Dwangju (KR)

(21) Appl. No.: 18/240,055

(22) Filed: Aug. 30, 2023

(30) Foreign Application Priority Data
Apr. 7, 2023 (KR) 10-2023-0045770

(51) Int. Cl. H01M 4/36; H01M 4/04; H01M 4/133; H01M 4/134; H01M 4/1393; H01M 4/1395; H01M 4/38; H01M 4/587; H01M 4/62; H01M 4/66; H01M 10/0585; H01M 10/42

(52) U.S. Cl. CPC H01M 4/366; H01M 4/0404; H01M 4/0426; H01M 4/133; H01M 4/134; H01M 4/1393; H01M 4/1395; H01M 4/386; H01M 4/587; H01M 4/62; H01M 4/661; H01M 4/667; H01M 10/0585; H01M 10/4235; H01M 2004/021; H01M 2004/027; H01M 2220/20

(57) ABSTRACT

Disclosed are an all-solid-state battery including a negative electrode layer in a thick-film form with a plurality of lithiophilic layers and a method of manufacturing the same.

### CROSS REFERENCE TO RELATED APPLICATION

The present application claims priority to Korean Patent Application No. 10-2023-0045770, filed Apr. 7, 2023, the entire contents of which is incorporated herein for all purposes by this reference.

### TECHNICAL FIELD

The present disclosure relates to an all-solid-state battery including a negative electrode layer in a thick-film form with a plurality of lithiophilic layers and a method of manufacturing the same.

### BACKGROUND

Recently, demand for batteries with high energy density has been growing in various fields, including electric vehicles. Therefore, the need for forming an electrode into a thick film to increase energy density is emerging. However, with electrodes formed into a thick film form, a migration distance of lithium ions increases in an all-solid-state battery. For this reason, the entire negative electrode may not be used. In addition, the amount of lithium charged fails to be fully accepted, resulting in a problem that lithium metal precipitates in the middle of the negative electrode.

To overcome the problems described above while improving the energy density of an all-solid-state battery, research has been conducted for improving lithium-ion conductivity of solid electrolytes or using negative electrode active materials with a high energy density, such as silicon.

However, an increase in lithium-ion conductivity may hardly affect electrodes in a thick-film form due to the direction of ion transfer and the resistance between materials. In addition, in the methods of using silicon-based negative electrode active materials, there is a problem of poor contact in the electrode interface due to the volume expansion of the materials during charging.

### SUMMARY

In preferred aspects, the disclosure provides an all-solid-state battery with high energy density and excellent durability.

In an aspect, provided is an all-solid-state battery including: a negative electrode current collector; a negative electrode layer positioned on the negative electrode current collector; a solid electrolyte layer positioned on the negative electrode layer; a positive electrode layer positioned on the solid electrolyte layer; and a positive electrode current collector positioned on the positive electrode layer.

The negative electrode layer may include: a first lithiophilic layer disposed on the negative electrode current collector and including a first metal capable of alloying with lithium, an oxide of the first metal, or combinations thereof; a first negative electrode active material layer disposed on the first lithiophilic layer and including a first negative electrode active material; a second lithiophilic layer disposed on the first negative electrode active material layer and including a second metal capable of alloying with lithium, an oxide of the second metal, or combinations thereof; and a second negative electrode active material layer disposed on the second lithiophilic layer and including a second negative electrode active material.

As used herein, the term “lithiophilic” refers to a material property that has affinity or be attracted toward lithium component (e.g., lithium ion). Often, a lithiophilic material, particular, lithiophilic metal, by forming an alloy or complex with lithium, can be used to control nucleation sites and stabilize Li (Li ion) deposition (e.g., dendrite) via regulation of nucleation overpotential of Li. Exemplary lithiophilic material (e.g., metal) may include lithium (Li), indium (In), gold (Au), silver (Ag), bismuth (Bi), zinc (Zn), aluminum (Al), iron (Fe), tin (Sn), and titanium (Ti).

Preferably, the first metal may suitably include one or more selected from the group consisting of lithium (Li), indium (In), gold (Au), silver (Ag), bismuth (Bi), zinc (Zn), aluminum (Al), iron (Fe), tin (Sn), and titanium (Ti).

The first negative electrode active material may suitably include a carbon-based active material, a silicon-based active material, or combinations thereof.

Preferably, the second metal may suitably include one or more selected from the group consisting of lithium (Li), indium (In), gold (Au), silver (Ag), bismuth (Bi), zinc (Zn), aluminum (Al), iron (Fe), tin (Sn), and titanium (Ti).

The second negative electrode active material may suitably include at a carbon-based active material, a silicon-based active material, or combinations thereof.

The negative electrode layer may have a thickness in a range of about 70 μm to 150 μm.

The negative electrode layer may include a first main surface being in contact with the negative electrode current collector and a second main surface being in contact with the solid electrolyte layer.

The second lithiophilic layer may be positioned in a space between a first plane spaced from the first main surface toward the solid electrolyte layer by a distance corresponding to about 40% of the thickness of the negative electrode layer along a direction of the thickness and a second plane spaced from the second main surface toward the negative electrode current collector by a distance corresponding to about 40% of the thickness of the negative electrode layer along a direction of the thickness.

The all-solid-state battery may satisfy Condition 1,

$$\begin{matrix}[ Condition 1 ] & \\ \frac{{x}_{1}}{3} \leq {x}_{2} \leq \frac{{x}_{1}}{2} & \end{matrix}$$

where x₁ may be a thickness of the first lithiophilic layer, and x₂ may be a thickness of the second lithiophilic layer.

In an aspect, provided is a method of manufacturing an all-solid-state battery including steps of: forming a negative electrode layer on a negative electrode current collector; forming a solid electrolyte layer on the negative electrode layer; forming a positive electrode layer on the solid electrolyte layer; and forming a positive electrode current collector on the positive electrode layer.

The forming of the negative electrode layer may include: forming a first lithiophilic layer by depositing a first metal capable of alloying with lithium, an oxide of the first metal, or combinations thereof on the negative electrode current collector; forming a first negative electrode active material layer containing a first negative electrode active material on the first lithiophilic layer; forming a second lithiophilic layer by depositing a second metal capable of alloying with lithium, an oxide of the second metal, or combinations thereof on the first negative electrode active material layer; and forming a second negative electrode active material layer containing a second negative electrode active material on the second lithiophilic layer.

In the forming of the first lithiophilic layer, the first metal, the oxide of the first metal, or the combinations thereof may be sputtered on the negative electrode current collector.

In the forming of the second lithiophilic layer, the second metal, the oxide of the second metal, or the combinations thereof may be sputtered on the first negative electrode active material layer.

The manufacturing method may satisfy Condition 2,

$$\begin{matrix}[ Condition 2 ] & \\ \frac{{t}_{1}}{3} \leq {t}_{2} \leq \frac{{t}_{1}}{2} & \end{matrix}$$

where t₁ may be a deposition time required for forming the first lithiophilic layer, and t₂ may be a deposition time required for forming the second lithiophilic layer.

Also provided is a vehicle that includes the all-solid-state battery as described herein.

According to various exemplary embodiment of the present disclosure, the all-solid-state battery with high energy density and excellent durability can be obtained.

Other aspects of the invention are disclosed infra.

### BRIEF DESCRIPTION OF THE DRAWINGS

FIG. 1 shows an exemplary all-solid-state battery according to an exemplary embodiment of the present disclosure;

FIG. 2 shows an exemplary negative electrode layer according to an exemplary embodiment of the present disclosure;

FIG. 3 shows details of an exemplary negative electrode layer according to an exemplary embodiment of the present disclosure;

FIG. 4 shows a result of analysis performed with a scanning electron microscope (SEM) for a cross-section of a negative electrode layer according to an exemplary embodiment of the present disclosure; and

FIG. 5 shows results of analysis performed with energy-dispersive X-ray spectroscopy (EDS) for the same cross-section of the negative electrode layer in FIG. 4.

### DETAILED DESCRIPTION

Above objectives, other objectives, features, and advantages of the present disclosure will be readily understood from the following preferred embodiments associated with the accompanying drawings. However, the present disclosure is not limited to the embodiments described herein and may be embodied in other forms. The embodiments described herein are provided so that the disclosure can be made thorough and complete and that the spirit of the present disclosure can be fully conveyed to those skilled in the art. Throughout the drawings, like elements are denoted by like reference numerals.

In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, without departing from the scope of the present disclosure, a first component may be referred as a second component, and a second component may be also referred to as a first component.

As used herein, the singular forms “a”, “an”, and “the” are intended to include the plural forms as well unless the context clearly indicates otherwise. It will be further understood that the terms “comprises”, “includes”, or “has” when used in this specification specify the presence of stated features, regions, integers, steps, operations, elements, and/or components, but do not preclude the presence or addition of one or more other features, regions, integers, steps, operations, elements, components and/or combinations thereof.

It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated. In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

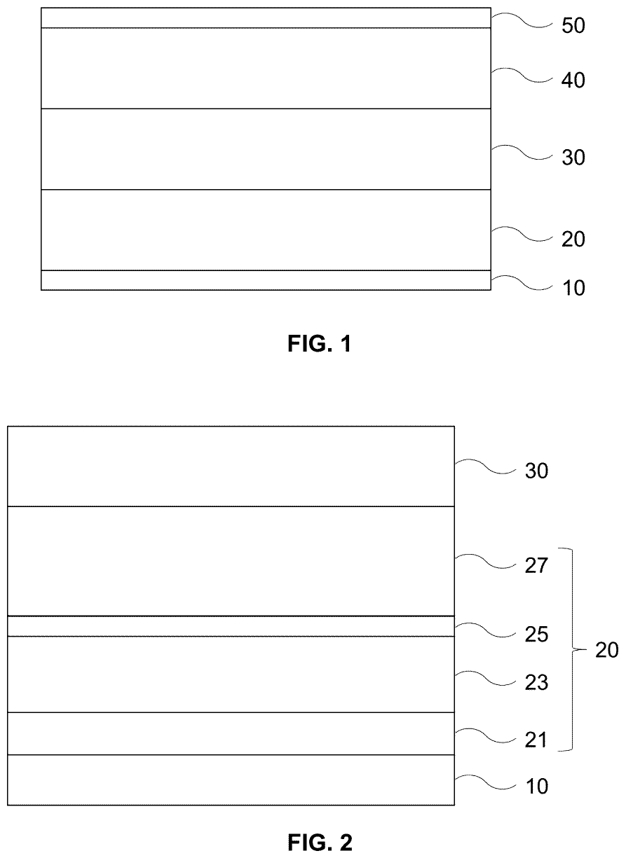

FIG. 1 shows an exemplary all-solid-state battery according to an exemplary embodiment of the present disclosure. As shown in FIG. 1, the all-solid-state battery may include a negative electrode current collector 10, a negative electrode layer 20 disposed on the negative electrode current collector 10, a solid electrolyte layer 30 disposed on the negative electrode layer 20, a positive electrode layer 40 disposed on the solid electrolyte layer 30, and a positive electrode current collector 50 disposed on the positive electrode layer 40.

The negative electrode current collector 10 may be an electrically conductive plate-shaped substrate. For example, the negative electrode current collector 10 may have a form of a sheet, a thin film, or foil.

The negative electrode current collector 10 may include a material that does not react with lithium. For example, the negative electrode current collector may include at least one material selected from the group consisting of nickel (Ni), copper (Cu), stainless steel, and combinations thereof.

The negative electrode current collector 10 has a thickness that is not particularly limited, and may be, for example, in a range of about 1 μm to 500 μm.

The negative electrode layer 20 is formed into a thick film, which has a thickness in a range of about 70 μm to about 150 μm.

In conventional all-solid-state batteries, when manufacturing a thick negative electrode, a passageway for lithium ions is increased, and the lithium ions are thus unable to be delivered to a portion of the negative electrode. As a result, energy density has not be sufficiently improved. Therefore, the present disclosure is characterized in that a plurality of lithiophilic layers capable of facilitating lithium ions to move to the negative electrode layer 20 is introduced to solve the problems described above.

FIG. 2 shows the negative electrode layer 20 according to the present disclosure. As shown in FIG. 2, the negative electrode layer 20 may include a first lithiophilic layer 21 disposed on the negative electrode current collector 10, a first negative electrode active material layer 23 disposed on the first lithiophilic layer 21, a second lithiophilic layer 25 disposed on the first negative electrode active material layer 23, and a second negative electrode active material layer 27 disposed on the second lithiophilic layer 25.

When charging the all-solid-state battery, lithium ions, released from the positive electrode layer 40, move to the negative electrode layer 20 through the solid electrolyte layer 30. The lithium ions are attracted to the second lithiophilic layer 25, and allowed to diffuse and move toward the negative electrode current collector 10. Then, the lithium ions passing through the second lithiophilic layer 25 are attracted to the first lithiophilic layer 21, and allowed to diffuse and move toward the negative electrode current collector 10. Particularly, in an existing thick-film negative electrode, a lithium-ion diffusion direction is not uniform, so lithium ions hardly spread throughout a negative electrode. However, in the negative electrode layer 20 according to an exemplary embodiment of the present disclosure, the first lithiophilic layer 21 and the second lithiophilic layer 25 facilitate the lithium lions to diffuse toward the negative electrode current collector 10. Thus, the lithium ions can spread throughout the negative electrode layer 20. In addition, in the negative electrode layer 20 according to an exemplary embodiment of the present disclosure, lithium-ion diffusion occurs uniformly in a direction of the negative electrode current collector 10, so the passageway for the lithium ions is shortened. Therefore, according to an exemplary embodiment of the present disclosure, the entire area of the negative electrode layer 20 in the thick film form may be used for an electrochemical reaction of the battery. In addition, lithium may be prevented from precipitating inside the negative electrode layer 20.

The first lithiophilic layer 21 may include a first metal capable of alloying with lithium, an oxide of the first metal, or combinations thereof.

The first metal may include one or more selected from the group consisting of lithium (Li), indium (In), gold (Au), silver (Ag), bismuth (Bi), zinc (Zn), aluminum (Al), iron (Fe), tin (Sn), and titanium (Ti).

The first lithiophilic layer 21 may suitably include zinc oxide (ZnO), gold (Au), or silver (Ag).

The first negative electrode active material layer 23 may include a first negative electrode active material, a first solid electrolyte, a first binder, and the like.

The first negative electrode active material may include a carbon-based active material, a silicon-based active material, or combinations thereof. The first negative electrode active material may preferably be a combination of the carbon-based active material and the silicon-based active material, and may be, for example, in a form in which a core unit including the carbon-based active material is coated with a shell unit including the silicon-based active material.

Examples of the carbon-based active material may include natural graphite, artificial graphite, and the like.

Examples of the silicon-based active material may include Si, SiOₓ (where 0<x<2), and the like.

The first negative electrode active material may have an average particle diameter that is not particularly limited, but may be, for example, in a range of about 8 μm to 10 μm.

The first solid electrolyte may include a sulfide-based solid electrolyte.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one of Ge, Zn, and Ga), Li₂S—GeS₂, Li₂S—SiS₂—Li₃PO₄, Li₂S—SiS₂—LiₓMO_{y} (where x and y are each independently a positive integer, and M is one of P, Si, Ge, B, Al, Ga, and In), Li₁₀GeP₂S₁₂, and the like.

Examples of the first binder may include styrene-butadiene rubber (SBR), nitrile butadiene rubber (NBR), butadiene rubber (BR), polyvinylidene fluoride, polytetrafluoroethylene, and the like.

The first negative electrode active material layer 23 may include the first negative electrode active material and the first solid electrolyte in a mass ratio in a range of about 6:4 to 8.5:1.5. In addition, the first negative electrode active material layer 23 may include about 1 part to 5 parts by weight of the first binder based on 100 parts by weight of the sum of the first negative electrode active material and the first solid electrolyte.

The second lithiophilic layer 25 may include a second metal capable of alloying with lithium, an oxide of the second metal, or combinations thereof.

The second metal may suitably include one or more selected from the group consisting of lithium (Li), indium (In), gold (Au), silver (Ag), bismuth (Bi), zinc (Zn), aluminum (Al), iron (Fe), tin (Sn), and titanium (Ti).

The second lithiophilic layer 25 may suitably include zinc oxide (ZnO), gold (Au), or silver (Ag). The second lithiophilic layer 25 may be the same as or different from those of the first lithiophilic layer 21 in components.

The second negative electrode active material layer 27 may include a second negative electrode active material, a second solid electrolyte, a second binder, and the like.

The second negative electrode active material may include a carbon-based active material, a silicon-based active material, or combinations thereof. The second negative electrode active material is preferably a combination of the carbon-based active material and the silicon-based active material, and may be, for example, in a form in which a core unit including the carbon-based active material is coated with a shell unit including the silicon-based active material. The second negative electrode active material may be the same as or different from the first negative electrode active material.

Examples of the carbon-based active material may include natural graphite, artificial graphite, and the like.

Examples of the silicon-based active material may include Si, SiOₓ (where 0<x<2), and the like.

The second negative electrode active material may have an average particle diameter (D50) that is not particularly limited, but may be, for example, in a range of about 8 μm to 10 μm.

The second solid electrolyte may include a sulfide-based solid electrolyte. The second solid electrolyte may be the same as or different from the first solid electrolyte.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one of Ge, Zn, and Ga), Li₂S—GeS₂, Li₂S—SiS₂—Li₃PO₄, Li₂S—SiS₂—LiₓMO_{y} (where x and y are each independently a positive integer, and M is one of P, Si, Ge, B, Al, Ga, and In), Li₁₀GeP₂S₁₂, and the like.

Examples of the second binder may include styrene-butadiene rubber (SBR), nitrile butadiene rubber (NBR), butadiene rubber (BR), polyvinylidene fluoride, polytetrafluoroethylene, and the like. The second binder may be the same as or different from the first binder.

The second negative electrode active material layer 27 may include the second negative electrode active material and the second solid electrolyte in a mass ratio in a range of about 6:4 to 8.5:1.5. In addition, the second negative electrode active material layer 27 may include about 1 part to 5 parts by weight of the second binder based on 100 parts by weight of the sum of the second negative electrode active material and the second solid electrolyte.

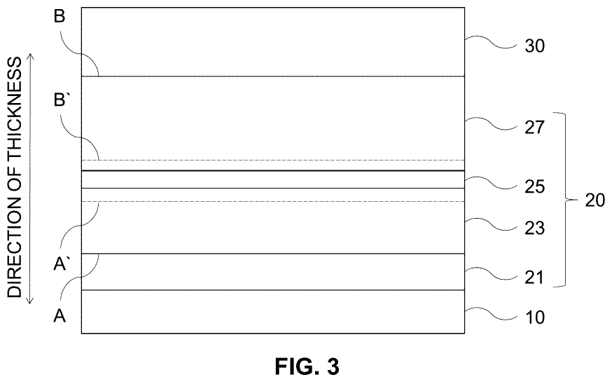

FIG. 3 shows specific details of the negative electrode layer 20 according to an exemplary embodiment of the present disclosure.

The negative electrode layer 20 may include a first main surface A being in contact with the negative electrode current collector 10 and a second main surface B being in contact with the solid electrolyte layer 30.

The second lithiophilic layer 25 may be positioned in a space between a first plane A′ toward the periphery of the first main surface A and a second plane B′ toward the periphery of the second main surface B within the negative electrode layer 20.

The first plane A′ may be an imaginary plane spaced from the first main surface A toward the solid electrolyte layer 30 by a distance corresponding to about 40% of the thickness of the negative electrode layer 20 along a direction of the thickness.

The second plane B′ may be an imaginary plane spaced from the second main surface B toward the negative electrode current collector 10 by a distance corresponding to about 40% of the thickness of the negative electrode layer 20 along a direction of the thickness.

When the second lithiophilic layer 25 is positioned in the space described above, lithium ion migration can be effectively facilitated.

The negative electrode layer 20 may satisfy Condition 1.

$$\begin{matrix}[ Condition 1 ] & \\ \frac{{x}_{1}}{3} \leq {x}_{2} \leq \frac{{x}_{1}}{2} & \end{matrix}$$

In this case, x₁ may be a thickness of the first lithiophilic layer, and x₂ may be a thickness of the second lithiophilic layer.

When the thickness of the lithiophilic layer 25 falls within the above range, lithium ion migration can be facilitated without increasing the electrode resistance of the negative electrode layer 20.

The solid electrolyte layer 30 is interposed between the negative electrode layer 20 and the positive electrode layer 40, and may include a lithium-ion conductive solid electrolyte.

The solid electrolyte may include an oxide-based solid electrolyte, a sulfide-based solid electrolyte, and the like.

Examples of the oxide-based solid electrolyte may include perovskite-type LLTO (Li₃ₓLa_{2/3-x}TiO₃), phosphate-based NASICON-type LATP (Li₁₊ₓAlₓTi₂₋ₓ(PO₄)₃), and the like.

Examples of the sulfide-based solid electrolyte may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS_{z}—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one of Ge, Zn, and Ga), Li₂S—GeS₂, Li₂S—SiS₂—Li₃PO₄, Li₂S—SiS₂—LiₓMO, (where x and y are each independently a positive integer, and M is one of P, Si, Ge, B, Al, Ga, and In), LinoGeP₂S₁₂, and the like.

The positive electrode layer 40 may include a positive electrode active material, a solid electrolyte, a conductive material, a binder, and the like.

The positive electrode active material may store and release lithium ions.

Examples of the positive electrode active material may include a rock-salt-layer-type active material, such as LiCoO₂, LiMnO₂, LiNiO₂, LiVO₂, Li₁₊ₓNi_{1/3}Co_{1/3}Mn_{1/3}O₂, and the like, a spinel-type active material, such as LiMn₂O₄, Li(Ni_{0.5}Mn_{1.5})O₄, and the like, an inversed-spinel-type active material, such as LiNiVO₄, LiCoVO₄, and the like, an olivine-type active material, such as LiFePO₄, LiMnPO₄, LiCoPO₄, LiNiPO₄, and the like, a silicon-containing active material, such as Li₂FeSiO₄, Li₂MnSiO₄, and the like, a rock-salt-layer-type active material in which a part of transition metal is substituted with dissimilar metal, such as LiNi_{0.8}Co_{(0.2-x)}AlₓO₂ (where 0<x<0.2) and the like, a spinel-type active material in which a part of transition metal is substituted with dissimilar metal, such as Li₁₊ₓMn_{2-x-y}M_{y}O₄ (where M is at least one Al, Mg, Co, Fe, Ni, and Zn, and 0<x+y<2), lithium titanate, such as Li₄Ti₅O₁₂, and the like.

The solid electrolyte may include an oxide-based solid electrolyte or a sulfide-based solid electrolyte. However, a sulfide-based solid electrolyte with high lithium-ion conductivity is preferably used. The sulfide-based solid electrolyte is not particularly limited, but examples thereof may include Li₂S—P₂S₅, Li₂S—P₂S₅—LiI, Li₂S—P₂S₅—LiCl, Li₂S—P₂S₅—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are each independently a positive integer, and Z is one of Ge, Zn, and Ga), Li₂S—GeS₂, Li₂S—SiS₂—Li₃PO₄, Li₂S—SiS₂—LiₓMO_{y} (where x and y are each independently a positive integer, and M is one of P, Si, Ge, B, Al, Ga, and In), LinoGeP₂S₁₂, and the like. The solid electrolyte included in the positive electrode layer 40 may be the same as or different from the solid electrolyte included in the solid electrolyte layer 30.

Examples of the conductive material may include carbon black, conductive graphite, ethylene black, graphene, and the like.

Examples of the binder may include butadiene rubber (BR), nitrile butadiene rubber (NBR), hydrogenated nitrile butadiene rubber (HNBR), polyvinylidene fluoride, polytetrafluoroethylene, and the like.

The positive electrode current collector 50 may include an electrically conductive plate-shaped substrate. The positive electrode current collector 50 may include aluminum foil.
the positive electrode current collector 50 may have a thickness that is not particularly limited, and may be, for example, in a range of about 1 μm to 500 μm.

In an aspect, provided is a method of manufacturing an all-solid-state battery, which may include steps of: forming a negative electrode layer on a negative electrode current collector; forming a solid electrolyte layer on the negative electrode layer; forming a positive electrode layer on the solid electrolyte layer; and forming a positive electrode current collector on the positive electrode layer.

The forming of the negative electrode layer may include: forming a first lithiophilic layer by depositing at least one selected from the group consisting of a first metal capable of alloying with lithium, an oxide of the first metal, and combinations thereof on the negative electrode current collector; forming a first negative electrode active material layer containing a first negative electrode active material on the first lithiophilic layer; forming a second lithiophilic layer by depositing at least one selected from the group consisting of a second metal capable of alloying with lithium, an oxide of the second metal, and combinations thereof on the first negative electrode active material layer; and forming a second negative electrode active material layer containing a second negative electrode active material on the second lithiophilic layer.

In the forming of the first lithiophilic layer, the first metal, the oxide of the first metal, or the combinations thereof may be sputtered on the negative electrode current collector.

In the forming of the first negative electrode active material layer, a first slurry containing the first negative electrode active material may be applied on the first lithiophilic layer and then dried. The first slurry may further include the first solid electrolyte, the first binder, and the like.

In the forming of the second lithiophilic layer, the second metal, the oxide of the second metal, or the combinations thereof may be sputtered on the second negative electrode active material layer.

In the forming of the second negative electrode active material layer, a second slurry containing the second negative electrode active material may be applied on the second lithiophilic layer and then dried. The second slurry may further include the second solid electrolyte, the second binder, and the like.

The forming of the negative electrode layer may satisfy Condition 2.

$$\begin{matrix}[ Condition 2 ] & \\ \frac{{t}_{1}}{3} \leq {t}_{2} \leq \frac{{t}_{1}}{2} & \end{matrix}$$

In this case, t₁ may be a deposition time required for forming the first lithiophilic layer, and t₂ may be a deposition time required for forming the second lithiophilic layer.

The deposition time is a variable related to the thickness of the respective lithiophilic layers, and the thickness thereof increases in proportion to the deposition time, regardless of applied power and pressure. Thus, Condition 2 may be intended to fulfill Condition 1 mentioned above.

Methods of forming the solid electrolyte layer, the positive electrode layer, and the positive electrode current collector are not particularly limited. Each component may be formed at the same time or at different times.

In addition, the manufacturing method may include not only forming the solid electrolyte layer, the positive electrode layer, and the positive electrode current collector directly on the negative electrode layer, the solid electrolyte layer, and the positive electrode layer, respectively, but also forming each component separately and then staking the components into a structure as illustrated in FIG. 1.

### EXAMPLE

Exemplary embodiments of the present disclosure will be described in more detail through the following examples. The following examples are only to help the understanding of the present disclosure, and the scope of the present disclosure is not limited thereto.

### Example

A nickel foil was prepared as a negative electrode current collector.

A first metal, gold (Au), was sputtered on the negative electrode current collector for about 60 seconds to form a first lithiophilic layer.

A first negative electrode active material, a first solid electrolyte, and a first binder were introduced into a non-polar solvent to prepare a first slurry. Graphite coated with silicon was used as the first negative electrode active material. A sulfide-based solid electrolyte represented by Li₆PS₅Cl was used as the first solid electrolyte. Butadiene rubber (BR) was used as the first binder. The first slurry was applied on the first lithiophilic layer and then dried to form a first negative electrode active material layer.

A second metal, gold (Au), was sputtered on the first negative electrode active material layer for about 30 seconds to form a second lithiophilic layer.

A second negative electrode active material, a second solid electrolyte, and a second binder were introduced into a non-polar solvent to prepare a second slurry. Graphite coated with silicon was used as the second negative electrode active material. A sulfide-based solid electrolyte represented by LisPSsCl was used as the second solid electrolyte. Butadiene rubber (BR) was used as the second binder. The second slurry was applied on the second lithiophilic layer and then dried to form a second negative electrode active material layer.

The first lithiophilic layer, the first negative electrode active material layer, the second lithiophilic layer, and the second negative electrode active material layer were compressed to obtain a negative electrode layer with a thickness of about 100 μm.

A position where the second lithiophilic layer is formed is shown in Table 1.

A solid electrolyte layer, a positive electrode layer, and a positive electrode current collector were attached onto the negative electrode layer to complete the manufacturing of an all-solid-state battery.

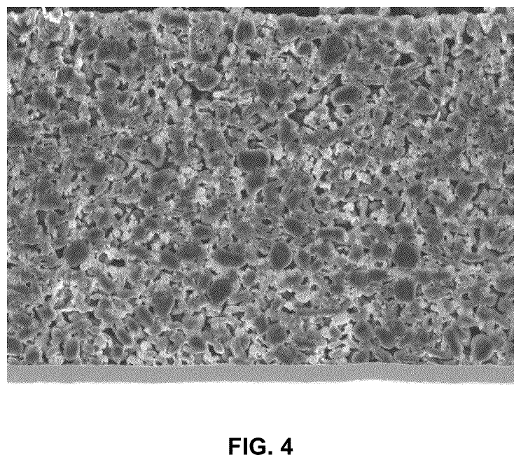

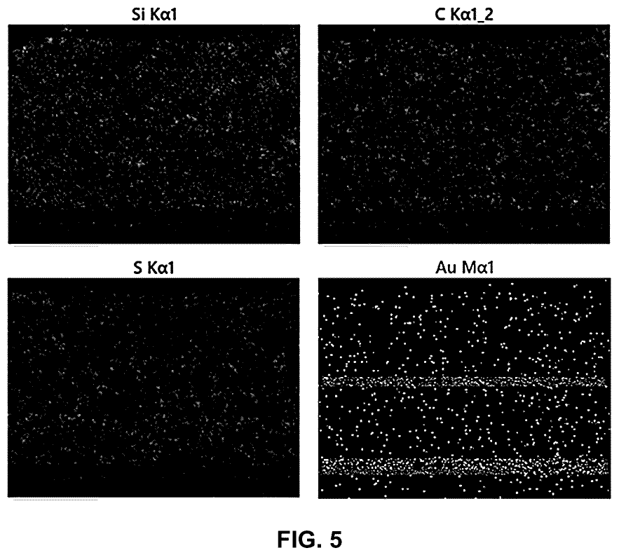

FIG. 4 shows a result of analysis performed with a scanning electron microscope (SEM) for a cross-section of the negative electrode layer according to one embodiment. FIG. 5 shows results of analysis performed with energy-dispersive X-ray spectroscopy (EDS) for the same cross-section of the negative electrode layer from FIG. 4. Referring to the results performed on a gold (Au) element, the first and second lithiophilic layers are well deposited in the negative electrode layer.

### Comparative Example 1

A negative electrode layer was formed without forming first and second lithiophilic layers.

A negative electrode active material, a solid electrolyte, and a binder were introduced into a non-polar solvent to prepare a slurry. The negative electrode active material, the solid electrolyte, and the binder were the same as the first negative electrode active material, the first solid electrolyte, and the binder, respectively, in Example. The slurry was applied on nickel foil, a negative electrode current collector, and then dried to form a negative electrode layer. The negative electrode layer was compressed so that the thickness thereof was adjusted to be about 100 μm.

A solid electrolyte layer, a positive electrode layer, and a positive electrode current collector were attached onto the negative electrode layer to complete the manufacturing of an all-solid-state battery.

### Comparative Example 2

A negative electrode layer was formed in the same manner as in Example, except that only the second lithiophilic layer was formed, without forming the first lithiophilic layer. A solid electrolyte layer, a positive electrode layer, and a positive electrode current collector were attached onto the negative electrode layer to complete the manufacturing of an all-solid-state battery.

### Comparative Example 3

A negative electrode layer was formed in the same manner as in Example, except that only the first lithiophilic layer was formed, without forming the second lithiophilic layer. A solid electrolyte layer, a positive electrode layer, and a positive electrode current collector were attached onto the negative electrode layer to complete the manufacturing of an all-solid-state battery.

### Comparative Example 4

A negative electrode layer was formed in the same manner as in Example, except that the second lithiophilic layer was positioned in a space between a first main surface A and a first plane A′ in FIG. 3. A solid electrolyte layer, a positive electrode layer, and a positive electrode current collector were attached onto the negative electrode layer to complete the manufacturing of an all-solid-state battery.

### Comparative Example 5

A negative electrode layer was formed in the same manner as in Example, except that the second lithiophilic layer was positioned in a space between a second main surface B and a second plane B′ in FIG. 3. A solid electrolyte layer, a positive electrode layer, and a positive electrode current collector were attached onto the negative electrode layer to complete the manufacturing of an all-solid-state battery.

### Comparative Example 6

A negative electrode layer was formed in the same manner as in Example, except that deposition time required for forming the first and second lithiophilic layers was changed as described in FIG. 1. A solid electrolyte layer, a positive electrode layer, and a positive electrode current collector were attached onto the negative electrode layer to complete the manufacturing of an all-solid-state battery.

### Comparative Example 7

A negative electrode layer was formed in the same manner as in Example, except that deposition time required for forming the first and second lithiophilic layers was changed as described in FIG. 1. A solid electrolyte layer, a positive electrode layer, and a positive electrode current collector were attached onto the negative electrode layer to complete the manufacturing of an all-solid-state battery.

Capacity retention rates of the all-solid-state batteries manufactured in Example and Comparative Examples 1 to 7 were measured under the same conditions after 30 cycles of charging and discharging. The results thereof are shown in Table 1.

TABLE 1

| | Presence or | Presence or | | | |
|---|---|---|---|---|---|
| | Absence of | Absence of | Position of | | Capacity |
| | First | Second | Second | Fulfillment of | retention |
| | lithiophilic | lithiophilic | lithiophilic | Unfulfillment of | rate at |
| Classification | layer | layer | layer¹⁾ | Condition 2 | 30 cycles |
| Comparative | X | X | — | — | 53% |
| Example 1 | | | | | |
| Comparative | X | ◯ | A′-B′ | — | 66% |
| Example 2 | | | | | |
| Comparative | ◯ | X | — | — | 71% |
| Example 3 | | | | | |
| Comparative | ◯ | ◯ | A-A′ | ◯ | 83% |
| Example 4 | | | | | |
| Example | ◯ | ◯ | A′-B′ | ◯ | 91% |
| Comparative | ◯ | ◯ | B′-B | ◯ | 88% |
| Example 5 | | | | | |
| Comparative | ◯ | ◯ | A′-B′ | X²⁾ | 79% |
| Example 6 | | | | | |
| Comparative | ◯ | ◯ | A′-B′ | X³⁾ | 75% |
| Example 7 | | | | | |

¹⁾The position of the second lithiophilic layer is indicated based on FIG. 3.
²⁾The deposition time (t₁) required for forming the first lithiophilic layer and the deposition time

(t₂) required for forming the second lithiophilic layer were set to meet

$${t}_{2} < \frac{{t}_{1}}{3} .$$

3) The deposition time (t₁) required for forming the first lithiophilic layer and the deposition time (t₂) required for forming the second lithiophilic layer were set to meet

$$\frac{{t}_{1}}{2} < {t}_{2} .$$

As shown in Table 1, Comparative Examples 1 to 3, including only at least one of the first and second lithiophilic layers, exhibit a capacity retention rate of 71% or less, which is extremely low. On the other hand, Example in which the conditions for the position of the second lithiophilic layer and the deposition time required for the respective lithiophilic layers are met exhibits a capacity retention rate of about 91%, which is extremely high.

While the present disclosure has been particularly shown and described with reference to exemplary embodiments thereof, it is to be understood that the scope of the present disclosure is not limited to the disclosed exemplary embodiments. Modified forms are also included within the scope of the present disclosure.

What is claimed is:

1. An all-solid-state battery comprising:
a negative electrode current collector;
a negative electrode layer disposed on the negative electrode current collector;
a solid electrolyte layer disposed on the negative electrode layer;
a positive electrode layer disposed on the solid electrolyte layer; and
a positive electrode current collector disposed on the positive electrode layer,
wherein the negative electrode layer comprises:
a first lithiophilic layer disposed on the negative electrode current collector and comprising a first metal capable of alloying with lithium, an oxide of the first metal, or combinations thereof;
a first negative electrode active material layer disposed on the first lithiophilic layer and comprising a first negative electrode active material;
a second lithiophilic layer disposed on the first negative electrode active material layer and comprising a second metal capable of alloying with lithium, an oxide of the second metal, or combinations thereof; and
a second negative electrode active material layer disposed on the second lithiophilic layer and comprising a second negative electrode active material.

2. The all-solid-state battery of claim 1, wherein the first metal comprises lithium, indium, gold, silver, bismuth, zinc, aluminum, iron, tin, titanium, or combinations thereof.

3. The all-solid-state battery of claim 1, wherein the first negative electrode active material comprises a carbon-based active material, a silicon-based active material, or combinations thereof.

4. The all-solid-state battery of claim 1, wherein the second metal comprises lithium, indium, gold, silver, bismuth, zinc, aluminum, iron, tin, titanium, or combinations thereof.

5. The all-solid-state battery of claim 1, wherein the second negative electrode active material comprises a carbon-based active material, a silicon-based active material, or combinations thereof.

6. The all-solid-state battery of claim 1, wherein the negative electrode layer has a thickness in a range of about 70 μm to 150 μm.

7. The all-solid-state battery of claim 1, wherein the negative electrode layer comprises:
a first main surface being in contact with the negative electrode current collector; and
a second main surface being in contact with the solid electrolyte layer, and
wherein the second lithiophilic layer is positioned in a space between a first plane spaced from the first main surface toward the solid electrolyte layer by a distance corresponding to about 40% of the thickness of the negative electrode layer along a direction of the thickness and a second plane spaced from the second main surface toward the negative electrode current collector by a distance corresponding to about 40% of the thickness of the negative electrode layer along a direction of the thickness.

8. The all-solid-state battery of claim 1, wherein the all-solid-state satisfies Condition 1,
$$\begin{matrix}[ Condition 1 ] & \\ \frac{{x}_{1}}{3} \leq {x}_{2} \leq \frac{{x}_{1}}{2} & \end{matrix}$$
wherein x₁ is a thickness of the first lithiophilic layer, and x₂ is a thickness of the second lithiophilic layer.

9. A method of manufacturing an all-solid-state battery, comprising:
forming a negative electrode layer on a negative electrode current collector;
forming a solid electrolyte layer on the negative electrode layer;
forming a positive electrode layer on the solid electrolyte layer; and
forming a positive electrode current collector on the positive electrode layer,
wherein the forming of the negative electrode layer comprises:
forming a first lithiophilic layer by depositing a first metal capable of alloying with lithium, an oxide of the first metal, or combinations thereof on the negative electrode current collector;
forming a first negative electrode active material layer comprising a first negative electrode active material on the first lithiophilic layer;
forming a second lithiophilic layer by depositing a second metal capable of alloying with lithium, an oxide of the second metal, or combinations thereof on the first negative electrode active material layer; and
forming a second negative electrode active material layer comprising a second negative electrode active material on the second lithiophilic layer.

10. The method of claim 9, wherein the first metal comprises lithium, indium, gold, silver, bismuth, zinc, aluminum, iron, tin, titanium, or combinations thereof.

11. The method of claim 9, wherein in the forming of the first lithiophilic layer, the first metal, the oxide of the first metal, or the combinations thereof is sputtered on the negative electrode current collector.

12. The method of claim 9, wherein the first negative electrode active material comprises a carbon-based active material, a silicon-based active material, or combinations thereof.

13. The method of claim 9, wherein the second metal comprises lithium, indium, gold, silver, bismuth, zinc, aluminum, iron, tin, titanium, or combinations thereof.

14. The method of claim 9, wherein in the forming of the second lithiophilic layer, second metal, the oxide of the second metal, or the combinations thereof is sputtered on the first negative electrode active material layer.

15. The method of claim 9, wherein the second negative electrode active material comprises a carbon-based active material, a silicon-based active material, or combinations thereof.

16. The method of claim 9, wherein the negative electrode layer has a thickness in a range of about 70 μm to 150 μm.

17. The method of claim 9, wherein the negative electrode layer comprises:
a first main surface being in contact with the negative electrode current collector; and
a second main surface being in contact with the solid electrolyte layer, and
wherein the second lithiophilic layer is positioned in a space between a first plane spaced from the first main surface toward the solid electrolyte layer by a distance corresponding to about 40% of the thickness of the negative electrode layer along a direction of the thickness and a second plane spaced from the second main surface toward the negative electrode current collector by a distance corresponding to about 40% of the thickness of the negative electrode layer along a direction of the thickness.

18. The method of claim 9, wherein the all-solid-state satisfies Condition 1,
$$\begin{matrix}[ Condition 1 ] & \\ \frac{{x}_{1}}{3} \leq {x}_{2} \leq \frac{{x}_{1}}{2} & \end{matrix}$$
wherein x₁ is a thickness of the first lithiophilic layer, and x₂ is a thickness of the second lithiophilic layer.

19. The method of claim 9, wherein the method satisfies Condition 2,
$$\begin{matrix}[ Condition 2 ] & \\ \frac{{t}_{1}}{3} \leq {t}_{2} \leq \frac{{t}_{1}}{2} & \end{matrix}$$
wherein t₁ is a deposition time required for forming the first lithiophilic layer, and t₂ is a deposition time required for forming the second lithiophilic layer.

20. A vehicle comprising an all-solid-state battery of claim 1.
